(19) United States
(12) Patent Application Publication
(10) Pub. No.: US 2019/0193774 A1
(43) Pub. Date: Jun. 27, 2019

(54) POWER STEERING APPARATUS

(71) Applicant: HITACHI AUTOMOTIVE SYSTEMS, LTD., Hitachinaka-shi, Ibaraki (JP)

(72) Inventor: Mitsuaki NAKADA, Atsugi-shi, Kanagawa (JP)

(73) Assignee: HITACHI AUTOMOTIVE SYSTEMS, LTD., Hitachinaka-shi, Ibaraki (JP)

(21) Appl. No.: 16/329,201

(22) PCT Filed: Mar. 16, 2017
(86) PCT No.: PCT/JP2017/010713

§ 371 Date: Feb. 27, 2019

(30) Foreign Application Priority Data
Aug. 31, 2016 (JP) 2016-169974

(51) Int. Cl. B62D 5/04; B62D 6/02

(52) U.S. Cl. CPC B62D 5/04; H02P 27/06; B62D 6/02

(57) ABSTRACT

Provided is a power steering apparatus capable of preventing or reducing a sudden change in a steering force. A power steering apparatus includes a steering mechanism configured to transmit a steering operation on a steering wheel to a turning target wheel, a first actuation portion and a second actuation portion configured to provide a steering force to the steering mechanism, and a controller configured to output a first driving instruction signal for controlling driving of the first actuation portion and a second driving instruction signal for controlling driving of the second actuation portion. The controller includes an output distribution control portion configured to change a ratio of the output of the first driving instruction signal and a ratio of the output of the second driving instruction signal. The output distribution control portion is configured to perform output distribution control of increasing the output ratio of one of the first driving instruction signal and the second driving instruction signal and reducing the output ratio of the other of the first driving instruction signal and the second driving instruction signal to a value greater than zero.

### TECHNICAL FIELD

The present invention relates to a power steering apparatus.

### BACKGROUND ART

PTL 1 discloses a power steering apparatus having a double system configuration for a control system and an output system of assist control.

### CITATION LIST

### Patent Literature

[PTL 1] Japanese Patent Application Public Disclosure No. 2015-61458

### SUMMARY OF INVENTION

### Technical Problem

However, the above-described conventional technique involves such a problem that, when an abnormality is confirmed in one of the systems, a steering force of a driver is subjected to a sudden change and steering controllability is deteriorated when an assist output is stopped or limited on the abnormality detected-side system.

One of objects of the present invention is to provide a power steering apparatus capable of preventing or reducing the sudden change in the steering force.

### Solution to Problem

A power steering apparatus according to one aspect of the present invention increases an output ratio of a steering force of one of a first actuation portion and a second actuation portion, and reduces an output ratio of a steering force of the other of the first actuation portion and the second actuation portion to a value greater than zero.

Therefore, the power steering apparatus can realize provision of a further appropriate steering force by changing the output ratios of the steering forces of the first actuation portion and the second actuation portion according to changes in a steering state, a driving state of the power steering apparatus, and the like. Further, the power steering apparatus prevents the output ratio of the steering force on an output reduction side from reaching zero, and therefore can prevent or reduce the sudden change in the steering force.

### BRIEF DESCRIPTION OF DRAWINGS

FIG. 1 illustrates a configuration of a power steering apparatus according to a first embodiment.

FIG. 2 illustrates a configuration of a control system of the power steering apparatus.

FIG. 3 is a control block diagram of a first system and a second system of an ECU 16.

FIG. 4 is a flowchart illustrating a flow of output distribution control processing according to the first embodiment.

FIG. 5 is a flowchart illustrating the flow of the output distribution control processing according to the first embodiment.

FIG. 6 is a flowchart illustrating the flow of the output distribution control processing according to the first embodiment.

FIG. 7 is a flowchart illustrating the flow of the output distribution control processing according to the first embodiment.

FIG. 8 is a flowchart illustrating the flow of the output distribution control processing according to the first embodiment.

FIG. 9 illustrates a method for distributing an output according to a required motor output.

FIG. 10 is a timing chart of output assignment ratios when an abnormality has occurred on an upstream side in one of the systems.

FIG. 11 is a timing chart of the output assignment ratios when an abnormality has occurred on a downstream side in the one of the systems.

FIG. 12 is a flowchart illustrating a flow of the output distribution control processing according to a fourth embodiment.

### DESCRIPTION OF EMBODIMENTS

### First Embodiment

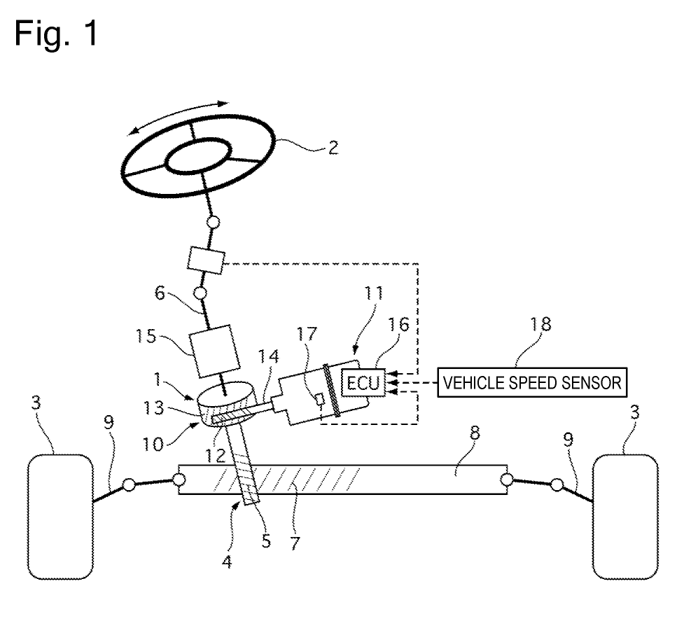

FIG. 1 illustrates a configuration of a power steering apparatus according to a first embodiment.

A steering mechanism 1 functions to turn front wheels (turning target wheels) 3 and 3 according to a rotation of a steering wheel 2, and includes a rack-and-pinion steering gear 4. A pinion gear 5 of the steering gear 4 is coupled with the steering wheel 2 via a steering shaft 6. A rack gear 7 of the steering gear 4 is provided on a rack shaft 8. Both ends of the rack shaft 8 are coupled with the front wheels 3 and 3 via tie rods 9 and 9, respectively. An electric motor (a first actuation portion and a second actuation portion) 11 is coupled with the steering shaft 6 via a speed reducer 10. The speed reducer 10 includes a worm 12 and a worm wheel 13. The worm 12 is provided integrally with a motor shaft 14 of the electric motor 11. A rotational torque from the motor shaft 14 is transmitted to the steering shaft 6 via the speed reducer 10. A steering torque sensor 15, which detects a steering torque, is mounted at the steering shaft 6. An ECU 16 and a steering angle sensor 17 are integrally provided on the electric motor 11. The steering angle sensor 17 detects steering angles of the front wheels 3 and 3 based on a rotational angle (a motor rotational angle) of the electric motor 11. The ECU 16 controls driving of the electric motor 11 and performs assist control of providing an assist torque to the steering mechanism 1 based on a steering torque signal (a first torque signal and a second torque signal), a steering angle signal, a vehicle speed signal detected by a vehicle speed sensor 18, and the like.

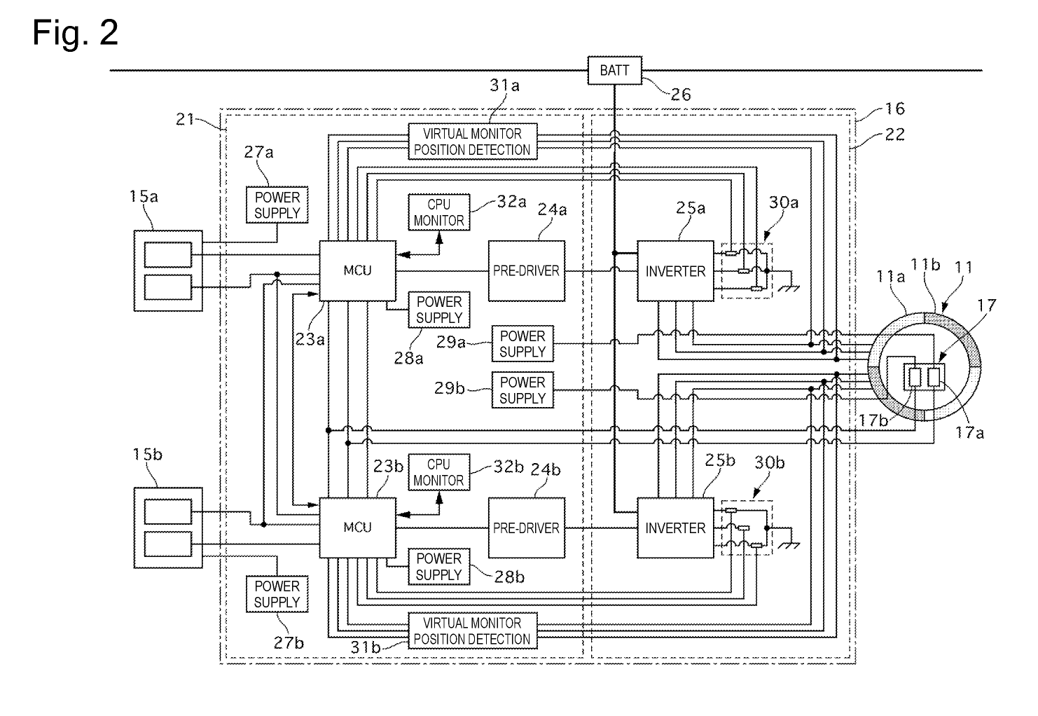

FIG. 2 illustrates a configuration of a control system of the power steering apparatus.

The electric motor 11 is a double three-phase motor including two pairs of stators (a first winging pair 11a and a second winding pair 11b) formed by three-phase windings. A maximum motor output is the same between when power is supplied only to the first winding pair (the first actuation portion) 11a, and when power is supplied to only to the second winding pair (the second actuation portion) 11b. The electric motor 11 generates an assist torque (a motor torque) according to a current from an inverter (a first inverter or a second inverter) 25. The ECU 16 has a double system configuration including a first system that supplies a current to the first winding pair 11a and a second system that supplies a current to the second winding pair 11b. In the following description, when these systems are distinguished from each other, “a” is added at an end of a reference numeral for a portion corresponding to the first system, and “b” is added at an end of a reference numeral for a portion corresponding to the second system. The ECU 16 includes a control board 21 and a power system board 22. The control board 21 is made of a printed-wiring assembly using a non-metallic base material such as an epoxy resin base material, and control system electronic components such as an MCU 23 and a pre-driver 24 are mounted on both surfaces thereof. The power system board 22 is constructed with use of a highly thermally conductive metallic circuit board, and includes the inverter 25 mounted on one surface thereof. The MCU 23 makes a calculation for the assist control, controls the motor current, detects an abnormality in a functional component, and performs processing for transitioning to a safe state. The pre-driver 24 drives a driving element of the inverter 25 based on a torque instruction (a first driving instruction signal or a second driving instruction signal) from the MCU 23. The inverter 25 converts direct-current power from a high-voltage battery 26 into alternating-current power, and supplies the converted power to the wiring pair of the electric motor 11.

The steering torque sensor 15 is, for example, a magnetostrictive sensor, and includes two Hall ICs individually. An output of one of these Hall ICs of each of a first steering torque sensor (a first detection portion) 15a and a second steering torque sensor (a second detection portion) 15b is input to the MCU 23 of the other system. The steering angle sensor 17 includes two magnetic detection elements 17a and 17b. Outputs of both the magnetic detection elements 17a and 17b are input to the MCUs 23. Power supply 27 generates a power source of the steering torque sensor 15 and supplies power thereto. Power supply 28 generates a power source of the MPU 23 and supplies power thereto. Power supply 29 generates a power source of the steering angle sensor 17 and supplies power thereto. Each of the power supply 27, the power supply 28, and the power supply 29 is connected to a low-voltage battery or an ignition line. A motor phase current sensor 30 is provided on the power system board 22. A motor rotational angle sensor 31 is provided on the control board 21. The motor rotational angle sensor 31 detects the motor rotational angle based on a change in inductance. Further, a CPU monitor 32 is provided on the control board 21. The CPU monitor 32 detects an abnormality in the MPU 23. The CPU monitor 32 has a function of disconnecting the power source when the abnormality is detected in the MPU 23.

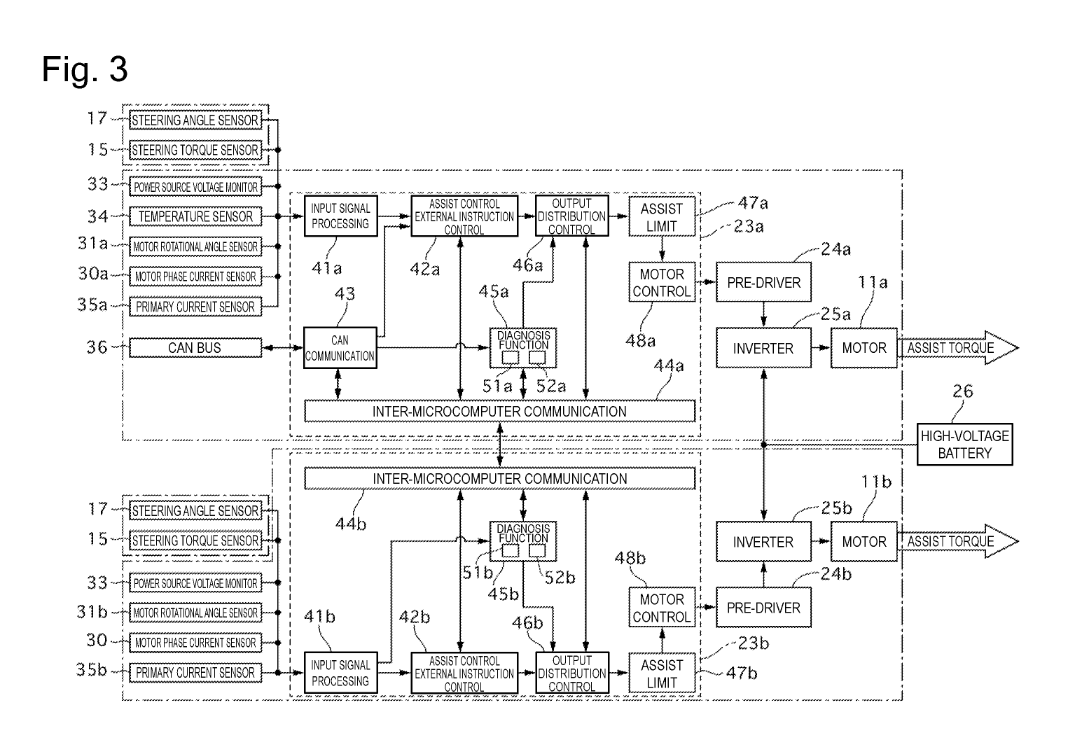

FIG. 3 is a control block diagram of a first system and a second system of the ECU 16.

An input signal processing portion 41 processes signals from the steering angle sensor 17, the steering torque sensor 15, a power source voltage monitor 33, a temperature sensor 34, the motor rotational angle sensor 31, the motor phase current sensor 30, and a primary current sensor 35a, and provides them to an assist control external instruction control portion 42. The power source voltage monitor 33 is provided on the power system board 22, and monitors a voltage of a power source line that supplies power from the high-voltage battery 26 to the ECU 16. The temperature sensor 34 is provided on the power system board 22, and detects a temperature of the wiring of the electric motor 11. The primary current sensor 35a is provided on the power system board 22, and detects the current introduced from the high-voltage battery 26 to the ECU 16.

The assist control external instruction control portion 42 determines a torque instruction from each of the signal inputs.

A CAN communication portion 43 transmits and receives information to and from outside via a CAN bus 36 by a CAN communication method. The CAN communication portion 43 is provided only to a first MPU (a first microprocessor) 23a. A second MPU (a second microprocessor) 23a includes no CAN communication portion.

An inter-microcomputer communication portion 44 is in charge of communication between the microcomputers. Information exchanged between the microcomputers include an abnormality counter value, abnormality cause information (for example, a location where an abnormality has occurred), an output assignment ratio instruction, the present output assignment ratio, the torque instruction, and the like. Details thereof will be described below.

A diagnosis function portion (a first abnormality determination portion or a second abnormality determination portion) 45 detects an abnormality in its own system and detects an abnormality in the other systems via the communication between the microcomputers. The diagnosis function portion 45 notifies the other system of the abnormality counter value and the abnormality cause information of its own system, and receives the abnormality detection and the abnormality cause information of the other system. Further, the diagnosis function portion 45 determines opposite assist, in which its own system and the other system provide assist in opposite directions from each other. The diagnosis function portion 45 starts incrementing the abnormality counter value when the abnormality is detected in its own system, and confirms the abnormality when the abnormality counter value reaches a predetermined abnormality confirmation value. The abnormality confirmation value may be variable according to an abnormality cause. The diagnosis function portion 45 includes an abnormality detection portion (a first abnormality detection portion or a second abnormality detection portion) 51 and an abnormality confirmation portion (a first abnormality confirmation portion or a second abnormality confirmation portion) 52. The abnormality detection portion 51 detects the abnormality in its own system. The abnormality confirmation portion 52 confirms the abnormality after the abnormality detection portion detects the abnormality.

An output distribution control portion (a first output distribution portion or a second output distribution portion) 46 sets an output assignment ratio of the other system, notifies the other system, and confirms consistency between the output assignment ratios of both the systems based on a result of the detection of the abnormality. The output distribution control portion 46 sets the output assignment ratio of its own system to 50% when no abnormality is detected in the other system, but transmits an instruction to reduce the output assignment ratio of the other system to 0% and also increases the output assignment ratio of its own system by the time the abnormality is confirmed, when the abnormality is detected in the other system. At this time, the output assignment ratios are controlled so as to be changed at the same speed between the two systems. The output distribution control portion 46 calculates an instruction after the output distribution by multiplying the torque instruction by the output assignment ratio. When the abnormality is confirmed in the other system, the output distribution control portion 46 carries out limit assist, which keeps the output assignment ratio of the other system at 0%, and also gradually reduces the output assignment ratio of its own system to a predetermined assignment ratio limit value (<50%) and thereafter keeps it constant. The output distribution control portion 46 may stop the assist control by setting the assignment limit value to 0%. Alternatively, the output distribution control portion 46 may continue the assist control by only its own system as long as possible without limiting the output assignment ratio of its own system.

An assist limit portion (a first upper limit value setting portion or a second upper limit value setting portion) 47 calculates a final torque instruction resultant from limiting an upper limit on the torque instruction after the output distribution to a set output upper limit value in view of a request to protect the electric motor 11 and the ECU 16 from excessive heat.

A motor control portion 48b outputs the final torque instruction to the pre-driver 24.

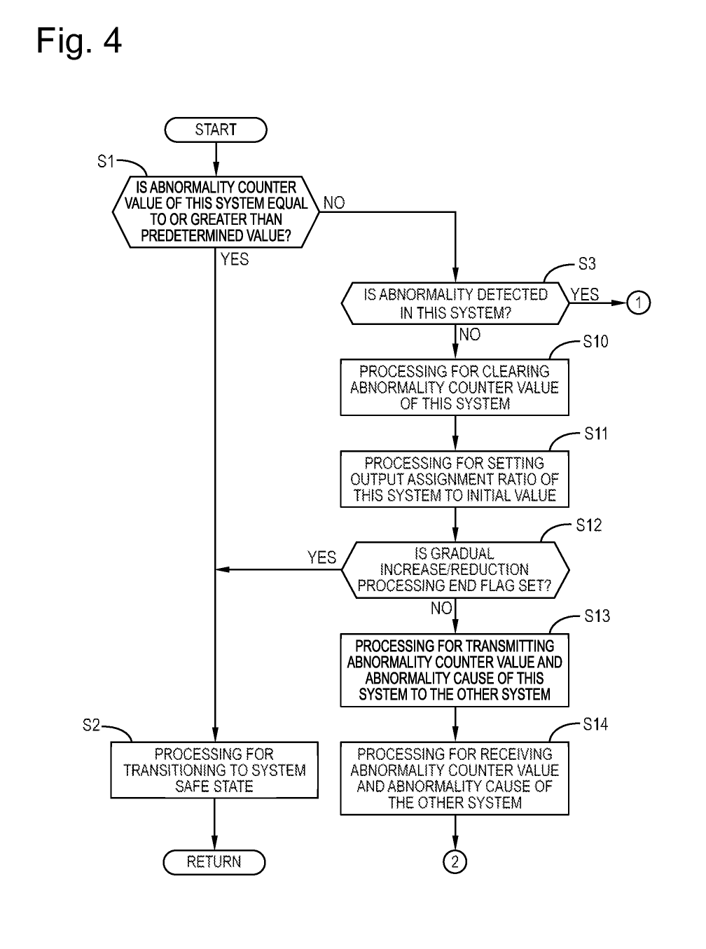

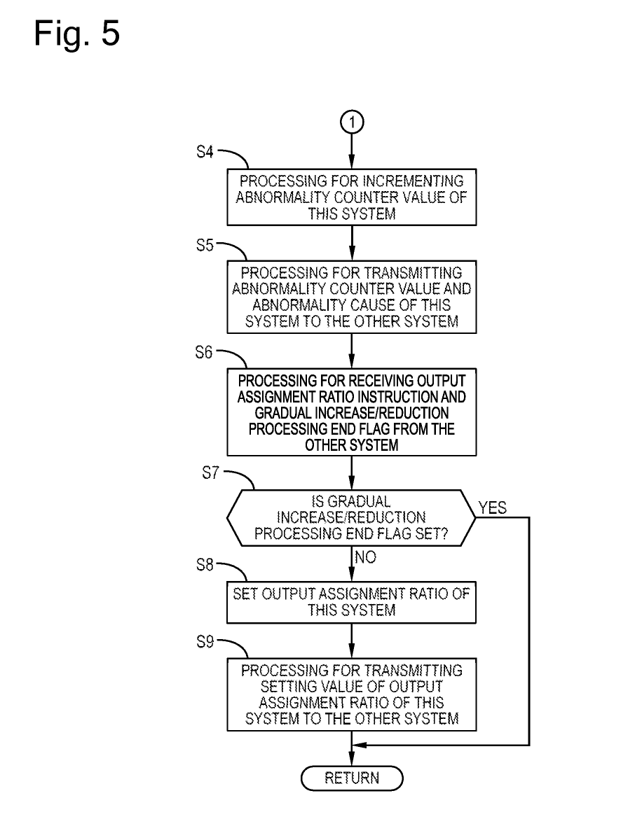

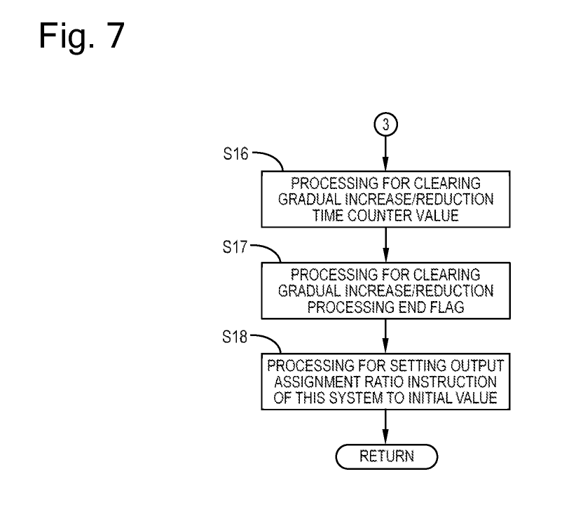

FIGS. 4 to 8 are flowcharts illustrating a flow of output distribution control processing according to the first embodiment. The output distribution control processing is performed by each of the first MPU 23a and the second MPU 23b.

In step S1, the MPU 23 determines whether the abnormality counter value of its own system is equal to or greater than a predetermined value. If the determination in step S1 is YES, the processing proceeds to step S2. If the determination in step S1 is NO, the processing proceeds to step S3. The predetermined value is set to a value smaller than the abnormality confirmation value.

In step S2, the MPU 23 performs processing for transitioning to a system safe state for setting the output assignment ratio of its own system to 0%. Then, the processing proceeds to RETURN.

In step S3, the MPU 23 determines whether the abnormality is detected in its own system. If the determination in step S3 is YES, the processing proceeds to S4. If the determination in step S3 is NO, the processing proceeds to S10.

In step S4, the MPU 23 adds one to (increments) the abnormality counter value of its own system.

In step S5, the MPU 23 transmits the abnormality counter value and the abnormality cause information of its own system to the other system.

In step S6, the MPU 23 receives the output assignment ratio instruction and an output assignment ratio gradual increase/reduction processing end flag (hereinafter referred to as a gradual increase/reduction processing end flag) from the other system.

In step S7, the MPU 23 determines whether the gradual increase/reduction processing end flag received in step S6 is set (=1). If the determination in step S7 is YES, the processing proceeds to RETURN. If the determination in step S7 is NO, the processing proceeds to step S8.

In step S8, the MPU 23 sets the output assignment ratio of its own system based on the output assignment ratio instruction received in step S6.

In step S9, the MPU 23 transmits the output assignment ratio set in step S8 to the other system. Then, the processing proceeds to RETURN.

In step S10, the MPU 23 clears the abnormality counter value of its own system (=0).

In step S11, the MPU 23 sets the output assignment ratio of its own system to an initial value of 50%.

In step S12, the MPU 23 determines whether the gradual increase/reduction processing end flag is set (=1). If the determination in step S12 is YES, the processing proceeds to RETURN. If the determination in step S12 is NO, the processing proceeds to step S13.

In step S13, the MPU 23 transmits the abnormality counter value and the abnormality cause information of its own system to the other system.

In step S14, the MPU 23 receives the abnormality counter value and the abnormality cause information of the other system.

In step S15, the MPU 23 determines whether the abnormality counter value of the other system that has been received in step S14 is 0. If the determination in step S15 is YES, the processing proceeds to step S16. If the determination in step S15 is NO, the processing proceeds to step S19.

In step S16, the MPU 23 clears an output assignment ratio gradual increase/reduction time counter value (hereinafter referred to as a gradual increase/reduction time counter value) (=0).

In step S17, the MPU 23 clears the gradual increase/reduction processing end flag (=0).

In step S18, the MPU 23 sets the output assignment ratio of its own system to the initial value of 50%. Then, the processing proceeds to RETURN.

In step S19, the MPU 23 determines whether the other system corresponds to the opposite assist, i.e., whether the assist direction of the other system is an opposite direction from the assist direction of its own system. If the determination in step S19 is YES, the processing proceeds to step S20. If the determination in step S19 is NO, the processing proceeds to step S23.

In step S20, the MPU 23 sets the output assignment ratio of its own system to 100%.

In step S21, the MPU 23 sets the output assignment ratio of the other system to 0%.

In step S22, the MPU 23 clears the gradual increase/reduction processing end flag (=1).

In step S23, the MPU 23 determines whether the abnormality has occurred on a downstream side in the other system based on the abnormality cause information of the other system that has been received in step S14. If the determination in step S23 is YES, the processing proceeds to step S24. If the determination in step S23 is NO, the processing proceeds to step S27. The “downstream side” corresponds to the motor control portion 48, the pre-driver 24, the inverter 25, and the electric motor 11 (the wiring pair thereof), and is determined that the abnormality has occurred on the downstream side if the abnormality has occurred in them. On the other hand, an “upstream side” corresponds to each of the sensors (the steering angle sensor 17, the steering torque sensor 15, the power source voltage monitor 33, the temperature sensor 34, the motor rotational angle sensor 31, the motor phase current sensor 30, and the primary current sensor 35), the CAN bus 36 (only the first system), the input signal processing portion 41, and the CAN communication portion 43, and is determined that the abnormality has occurred on the upstream side if the abnormality has occurred in them.

In step S24, the MPU 23 performs gradual increase processing for setting the output assignment ratio of its own system to a previous value+a predetermined amount ΔA. The predetermined amount ΔA is set to a value that allows the output assignment ratio of its own system to reach 100% and also allows the output assignment ratio of the other system to 0% when the gradual increase/reduction time counter value reaches a predetermined value after being incremented by three for each control cycle.

In step S25, the MPU 23 performs gradual reduction processing for setting the output assignment ratio of the other system to a previous value−the predetermined amount ΔA.

In step S26, the MPU 23 adds three to the gradual increase/reduction time counter value.

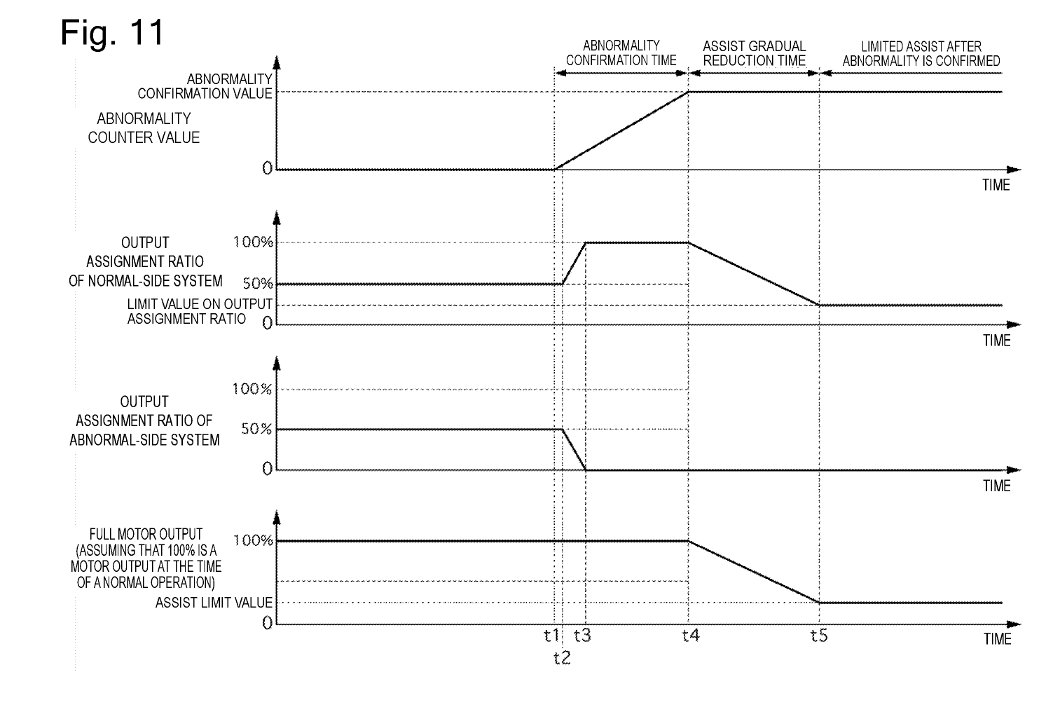

In step S27, the MPU 23 determines whether a required motor output can be satisfied by its own system alone. If the determination in step S27 is YES, the processing proceeds to step S28. If the determination in step S27 is NO, the processing proceeds to step S33. In this step, the MPU 23 determines that the required motor output can be satisfied by its own system alone if the output assignment ratio of the its own system is set to 100% and the output assignment ratio of the other system is set to 0%, i.e., if the maximum motor output of one system is equal to or greater than the required motor output according to the torque instruction (refer to FIG. 11(a)). On the other hand, the MPU 23 determines that the required motor output cannot be satisfied by its own system alone if the maximum motor output of one system falls below the required motor output (refer to FIG. 11(b)).

In step S28, the MPU 23 performs gradual increase processing for setting the output assignment ratio of its own system to the previous value+a predetermined amount ΔB. The predetermined amount ΔB is set to one third as large as ΔA and a value that allows the output assignment ratio of its own system to reach 100% and also allows the output assignment ratio of the other system to 0% at the same time when the gradual increase/reduction time counter value reaches the predetermined value after being incremented by one for each control cycle.

In step S29, the MPU 23 performs gradual reduction processing for setting the output assignment ratio of the other system to the previous value−the predetermined amount ΔB.

In step S30, the MPU 23 adds one to (increments) the gradual increase/reduction time counter value.

In step S31, the MPU 23 determines whether the gradual increase/reduction time counter value reaches the predetermined value. If the determination in step S31 is YES, the processing proceeds to step S32. If the determination in step S31 is NO, the processing proceeds to step S35.

In step S32, the MPU 23 sets the gradual increase/reduction processing end flag (=1).

In step S33, the MPU 23 sets the output assignment ratio of its own system to 100%.

In step S34, the MPU 23 sets the output assignment ratio of the other system that compensates for an amount corresponding to an insufficient output for the required motor output.

In step S35, the MPU 23 uses the output assignment ratio of the other system that has been set in step S21, step S25, step S29, or step S34 as the output assignment ratio instruction, and transmits it to the other system together with the gradual increase/reduction processing end flag set in step S32.

In step S36, the MPU 23 receives the output assignment ratio setting value of the other system from the other system.

In step S37, the MPU 23 determines whether the output assignment ratios of its own system and the other system are consistent with each other. If the determination in step S37 is YES, the processing proceeds to RETURN. If the determination in step S37 is NO, the processing proceeds to step S38.

In step S38, the MPU 23 performs processing for transitioning to the system safe state for setting the output assignment ratio of the other system to 0%. Then, the processing proceeds to RETURN.

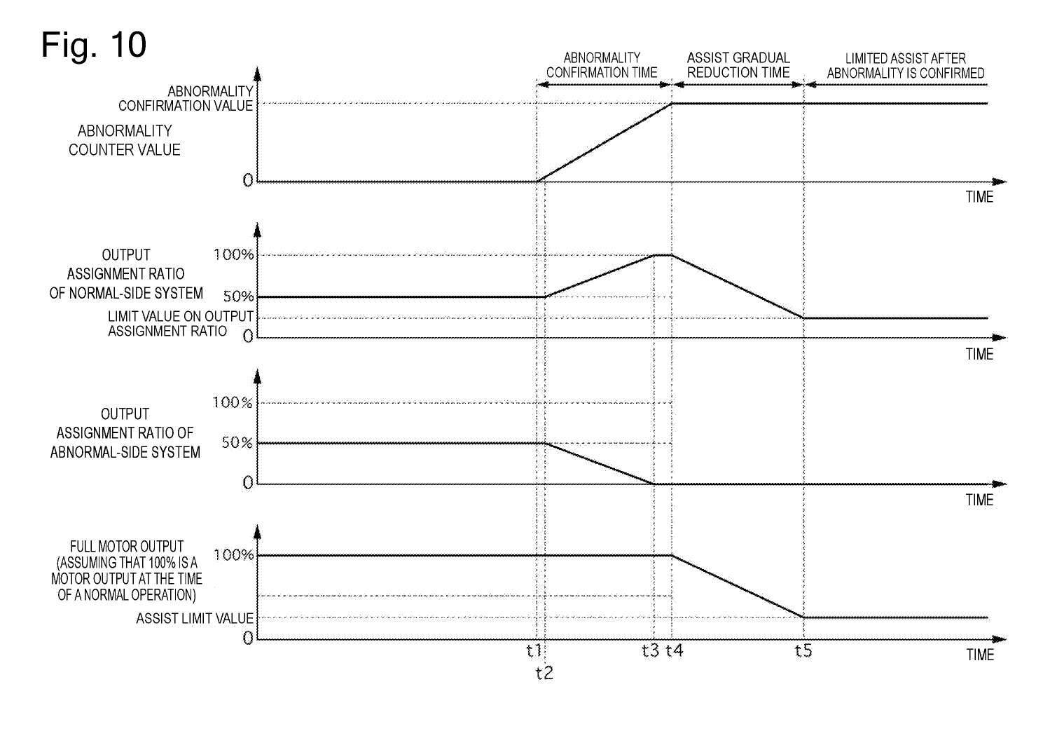

FIG. 10 is a timing chart of the output assignment ratios when the abnormality has occurred on the upstream side in one of the systems. Hereinafter, one of the systems and the other of the systems will be referred to as an abnormality detected-side system and a normal-side system.

At time t1, the abnormality has occurred on the upstream side in one of the systems but the abnormality is not detected, so that a flow of S1 to S3 to S10 to S11 to S12 to S13 to S14 to S15 to S16 to S17 to S18 is repeated in both the output distribution control processing procedures in the two systems. Therefore, the output assignment ratios of both the systems are kept at the initial value of 50%.

At time t2, the flow is switched to S1 to S3 to S4 to S5 to S6 to S7 to S8 to S9 in the abnormality detected-side system because the abnormality detected-side system detects the abnormality in its own system. More specifically, the abnormality detected-side system detects the abnormality in its own system in S3, increments the abnormality counter value in S4, transmits the abnormality counter value and the abnormality cause information in S5, receives the output assignment ratio instruction in S6, sets the output assignment ratio in S8, and transmits the output assignment ratio in S9. On the other hand, in the normal-side system, the flow is switched to S1 to S3 to S10 to S11 to S12 to S13 to S14 to S15 to S19 to S23 to S27 to S28 to S29 to S30 to S31 to S35 to S36 to S37. More specifically, the normal-side system receives the abnormality counter value and abnormality cause information in S14, determines that the other system does not correspond to the opposite assist in S19, determines that the abnormality has not occurred on the downstream side in S23, determines that the required motor output can be satisfied by its own system alone in S27, sets the output assignment ratio of its own system to the previous value+AB in S28, sets the output assignment ratio on the abnormality detection side to the previous value−ΔB in S29, adds 1 to the gradual increase/reduction time counter value in S30, transmits the output assignment ratio on the abnormality detected side as the output assignment ratio instruction in S35, receives the output assignment ratio on the abnormality detected side in S36, and confirms the consistency between the output assignment ratios of both the systems in S37. As a result, during a period from time t2 to time t3, the output assignment ratio of the normal-side system gradually increases and the output assignment ratio of the abnormality detected-side system gradually reduces.

At time t3, because the gradual increase/reduction time counter value reaches the predetermined value, the normal-side system sets the gradual increase/reduction processing end flag in S32, so that the flow is switched to S1 to S3 to S10 to S11 to S12 from a next control cycle. On the other hand, the flow is switched to S1 to S3 to S4 to S5 to S6 to S7 in the abnormality detected-side system because the gradual increase/reduction processing end flag is set. As a result, the output assignment ratio of the normal-side system increases to 100%, and the output assignment ratio of the abnormality detected-side system reduces to 0%.

At time t4, the abnormality counter value reaches the predetermined value, and an abnormality confirmation time has elapsed, so that the output assignment ratio of the normal-side gradually reduces and the output assignment ratio of the abnormality detected-side system is kept at 0%.

At time t5, an assist gradual reduction time has elapsed since time t4, and the output assignment ratio of the normal-side system reaches a distribution ratio/assignment ratio limit value.

FIG. 11 is a timing chart of the output assignment ratios when the abnormality has occurred on the downstream side in the one of the systems.

At time t1, the abnormality has occurred on the downstream side in the one of the systems but the abnormality is not detected, so that the output distribution control processing is performed in both the systems in a similar manner to the period since time t1 to time t2 illustrated in FIG. 10.

At time t2, the abnormality detected-side system detects the abnormality in its own system. The flow of the output distribution control is performed in a similar manner to the period since time t2 to time t3 illustrated in FIG. 10 in the abnormality detected-side system, but the location where the abnormality has occurred is positioned on the downstream side, so that the processing proceeds according to a flow of S1 to S3 to S10 to S11 to S12 to S13 to S14 to S15 to S19 to S23 to S24 to S25 to S26 to S31 to S35 to S36 to S37 in the normal-side system. Therefore, compared to the flow in the case of FIG. 10, differences therefrom is that the normal-side system determines that the abnormality has occurred on the downstream side in S23, sets the output assignment ratio of its own system to the previous value+ΔA in S24, sets the output assignment ratio of the abnormality detected-side system to the previous value−ΔA in S25, and adds 3 to the gradual increase/reduction time counter value in S26. Therefore, the output assignment ratios of both the systems are changed at speeds three times as high as those in the case of FIG. 10, i.e., those in the case where the abnormality has occurred on the upstream side.

A period since time t3 to t5 is similar to the period since time t3 to time t5 illustrated in FIG. 10, and therefore a description thereof will be omitted here.

In this manner, if the abnormality is detected in the one of the systems, the power steering apparatus according to the first embodiment performs the output distribution control of reducing the output assignment ratio of the abnormality detected-side system while increasing the output assignment ratio of the normal-side system. By this control, the power steering apparatus can improve reliability of the assist control when the abnormality is detected, while preventing or reducing a sudden change in a steering force and an increase in a steering load on the driver. Further, in the output distribution control, the power steering apparatus continuously changes the output assignment ratios of both the systems, and therefore can further prevent or reduce the change in the steering force.

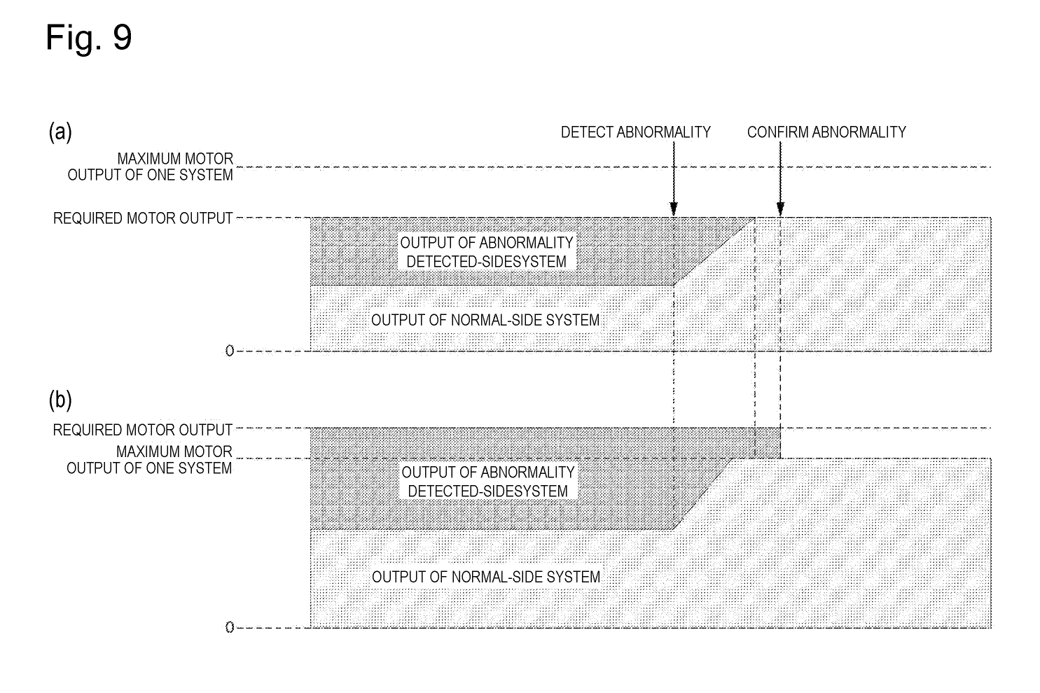

The output distribution control portion 46 performs the output distribution control since the diagnosis function portion 45 detects the abnormality in its own system until confirming the abnormality. The conventional steering apparatus fixes the output assignment ratios of both the systems since the abnormality is detected until the abnormality is confirmed, thereby causing a sudden change in the steering force of the driver when reducing the output assignment ratio of the abnormality detected-side system upon confirming the abnormality, thus leading to deterioration of the steering controllability. On the other hand, in the first embodiment, the power steering apparatus reduces in advance the output assignment ratio of the abnormality detected-side system before the abnormality is confirmed by utilizing the time since the abnormality is detected until the abnormality is confirmed, and therefore can prevent or reduce the sudden change in the steering force when the abnormality is confirmed. At this time, the power steering apparatus ends the output distribution control by the time the abnormality is confirmed, and therefore can sufficiently reduce the output assignment ratio of the abnormality detected-side system before the abnormality is confirmed, thereby improving the reliability of steering control since the abnormality is detected until the abnormality is confirmed. Further, when the required motor output is equal to or smaller than the maximum motor output that the normal-side system can output alone, the power steering apparatus reduces the output assignment ratio of the abnormality detected-side system to 0% by the time the abnormality is confirmed, as illustrated in FIG. 9(a). By this control, the power steering apparatus can further improve the reliability of the steering control since the abnormality is detected until the abnormality is confirmed, and eliminate the change in the steering force when the abnormality is confirmed. Further, the power steering apparatus can operate under such a situation that the normal system can cover the steering force by itself, thereby lowering a risk of increasing in the steering load on the driver.

On the other hand, when the required motor output exceeds the maximum motor output that the normal-side system can output alone, the power steering apparatus causes the abnormality detected-side system to bear a difference between the required motor output and the maximum motor output of the normal-side system without reducing the output assignment ratio of the abnormality detected-side system to 0%, until the abnormality is confirmed, as illustrated in FIG. 9(b). By this control, the power steering apparatus can prevent or cut down the increase in the steering load on the driver. Now, in FIG. 11(b), a step is generated in the assist torque according to setting the output assignment ratio of the abnormality detected-side system to 0% when the abnormality is confirmed. However, such a scene that the required motor output exceeds the maximum motor output of the normal-side system takes place when the vehicle is stopped or is running at an extremely low speed, and therefore a shock on a steering wheel unlikely occurs. Further, when the vehicle is stopped or is running at the extremely low speed, a vehicle behavior is not affected even with some change made to the steering wheel 2 due to the change in the assist torque.

The output distribution control portion 46 starts the output distribution control if receiving the signal indicating that the abnormality has occurred in the other system (the abnormality counter value >0) from the diagnosis function portion 45 of the other system. By this operation, the power steering apparatus can realize the output distribution control according to the occurrence of the abnormality. On the other hand, if the abnormality has occurred in the diagnosis function portion 45 or the output distribution control portion 46, the output distribution control is not started because the communication between the microcomputers is not carried out. Therefore, the power steering apparatus can prevent or reduce, for example, such inconvenience that both the systems increase the motor output according to the abnormality in the diagnosis function portion 45 or the output distribution control portion 46, thereby resulting in an excessively lightened steering feeling.

The diagnosis function portion 45 transmits the signal according to the cause of the abnormality in its own system (the abnormality cause information) to the MPU 23 of the other system. By this operation, the power steering apparatus can realize the output distribution control according to the cause of the abnormality (the location where the abnormality has occurred). More specifically, the output distribution control portion 46 ends the output distribution control earlier when the abnormality is detected on the downstream side in the other system than when the abnormality is detected on the upstream side in the other system. If the cause of the abnormality lies in the steering torque sensor 15, the assist control can continue by the abnormality detected-side system based on the output assignment ratio set by the output distribution control portion 46 of the normal-side system. However, if the cause of the abnormality lies in the inverter 25 or the electric motor 11, continuing the assist control by the abnormality detected-side system leads to a reduction in the reliability of the assist control. Therefore, the power steering apparatus can improve the reliability of the assist control when the abnormality is detected by completing the output distribution control earlier when the abnormality is detected on the downstream side than when the abnormality is detected on the upstream side.

The output distribution control portion 46 sets the output assignment ratios of the first system and the second system if receiving the signal indicating that the abnormality has occurred in the other system (the abnormality counter value >0) from the diagnosis function portion 45 of the other system. The power steering apparatus can avoid setting of an inappropriate output assignment ratio and thus improve the reliability of the assist control when the abnormality is detected by determining the output assignment ratios of both the systems by the output distribution control portion 46 of the normal-side system.

The MPU 23 includes the assist limit portion 47 that limits the upper limit value on the torque instruction after the output distribution that is output from the output distribution control portion 46. The power steering apparatus can set the upper limit value in consideration of the output distribution by including the assist limit portion 47 provided on the downstream side of the output distribution control portion 46, thereby improving the reliability of the assist control when the abnormality is detected, while achieving the protection of the electric motor 11 and the ECU 16 from excessive heat.

### Second Embodiment

A power steering apparatus according to a second embodiment is different from the first embodiment in terms of a part of the output distribution control processing.

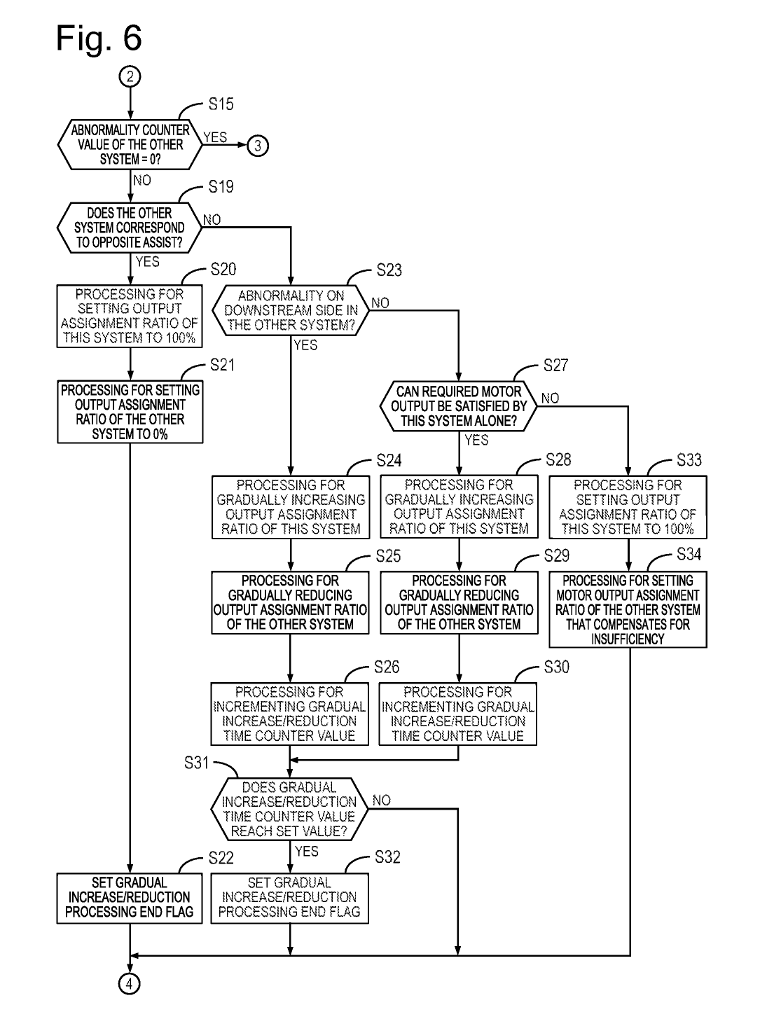

In step S24 illustrated in FIG. 6, the MPU 23 sets the output assignment ratio of its own system to 100%.

In step S25, the MPU 23 sets the output assignment ratio of the other system to 0%.

In step S26, the MPU 23 adds the predetermined value to the gradual increase/reduction time counter value.

In the second embodiment, the output distribution control portion 46 sets the output assignment ratio of the other system to 0% and the output assignment ratio of its own system to 100% when receiving the signal indicating that the abnormality is detected on the downstream side in the other system (the abnormality counter value >0) from the diagnosis function portion 45 of the other system. In other words, the power steering apparatus can improve the reliability of the assist control when the abnormality is detected by completing the output distribution control immediately when the abnormality is detected if the cause of the abnormality lies in the inverter 25 or the electric motor 11.

### Third Embodiment

A power steering apparatus according to a third embodiment is different from the first embodiment in terms of continuing the assist control in both the systems even after the abnormality is confirmed, when the cause of the abnormality in the other system lies in the steering torque sensor 15.

The output distribution control portion 46 performs the output distribution control so as to cause the other system to continue the assist control with use of the signal from the steering torque sensor 15 of its own system after the abnormality in the other system is confirmed by the diagnosis function portion 45 of its own system, if the cause of the abnormality in the other system lies in the steering torque sensor 15. The output assignment ratios of both the systems after the abnormality is confirmed are set to 50% and 50%. The power steering apparatus can prevent or cut down the increase in the steering load on the driver when the abnormality has occurred in the steering torque sensor 15 by causing both the systems to continue the assist control even after the abnormality is confirmed with use of an alternative torque signal from the normal steering torque sensor 15.

### Fourth Embodiment

A power steering apparatus according to a fourth embodiment is different from the first embodiment in terms of a part of the output distribution control processing. Differences are as follows.

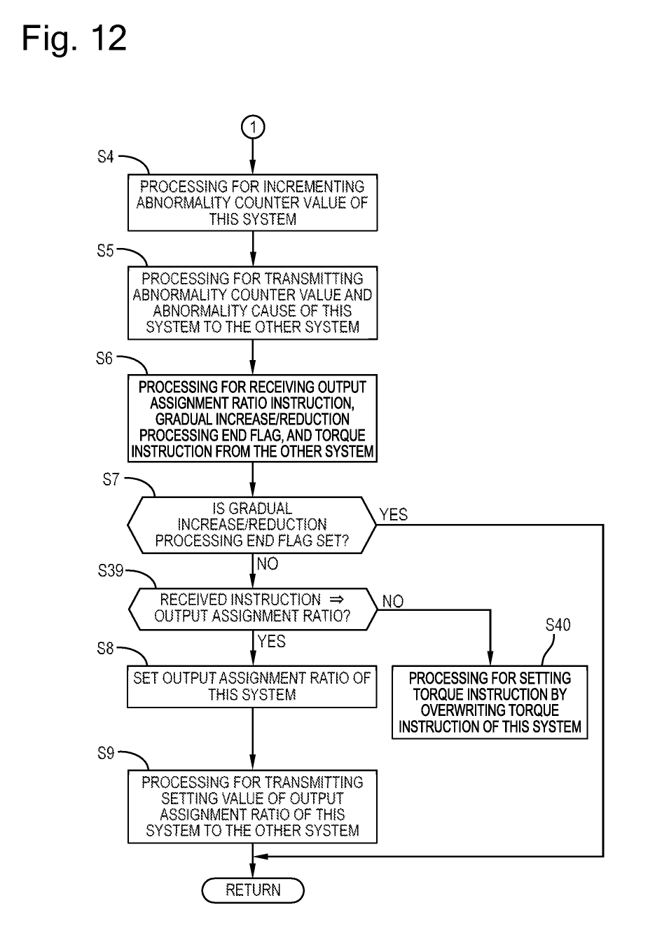

In step S6 illustrated in FIG. 12, the MPU 23 receives the output assignment ratio instruction, the gradual increase/reduction processing end flag, and the torque instruction from the other system.

In step S39, the MPU 23 determines whether the output assignment ratio instruction has been received in step S6. If the determination in step S39 is YES, the processing proceeds to step S8. If the determination in step S39 is NO, the processing proceeds to step S40.

In step S40, the MPU 23 overwrites the torque instruction of its own system with the torque instruction received in step S6. Then, the processing proceeds to RETURN.

In step S34 illustrated in FIG. 6, the MPU 23 sets the torque instruction of the other system that compensates for the amount corresponding to the insufficient output for the required motor output.

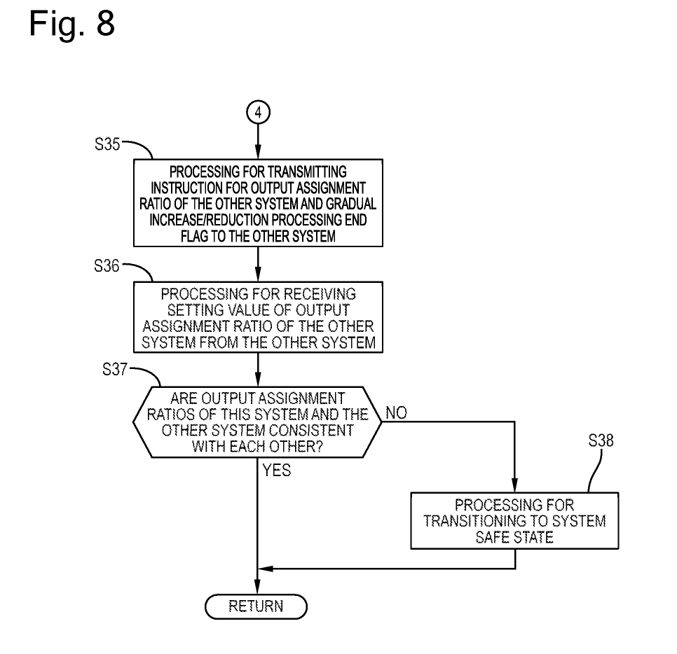

Referring to FIG. 8, in step S35, the MPU 23 transmits the output assignment ratio of the other system that has been set in step S21, step S25, or step S29, or the torque instruction of the other system that has been set in step S34 to the other system together with the gradual increase/reduction processing end flag set in step S32.

In the fourth embodiment, the output distribution control portion 46 sets the torque instruction of the other system that compensates for the amount corresponding to the insufficient output for the required motor output and outputs it to the MPU 23 of the other system, if the abnormality is detected on the upstream side in the other system and the required motor output is determined to be unable to be satisfied by its own system alone. The assist control external instruction control portion 42 of the abnormality detected-side system drives the inverter 25 of its own system with use of the torque instruction transmitted from the MPU 23 of the normal-side system. The power steering apparatus can avoid setting of an inappropriate torque instruction and thus improve the reliability of the assist control when the abnormality is detected, by causing the normal-side system to set the torque instruction of the abnormality detected-side system. A detection cycle of the steering torque sensor 15 is sufficiently long compared to the control cycle of the electric motor 11, and therefore the torque instruction determined from the steering torque can be transmitted to the MPU 23 of the other system via the communication between the microcomputers.

### Other Embodiments

Having described the embodiments for implementing the present invention, the specific configuration of the present invention is not limited to the configurations of the embodiments, and the present invention also includes a design modification and the like thereof made within a range that does not depart from the spirit of the present invention. Further, the individual components described in the claims and the specification can be arbitrarily combined or omitted within a range that allows them to remain capable of achieving at least a part of the above-described objects or producing at least a part of the above-described advantageous effects.

For example, in the embodiments, the first actuation portion and the second actuation portion are embodied by the wiring pairs (the first wiring pair 11a and the second wiring pair lib) in the electric motor 11. However, the first actuation portion and the second actuation portion may be provided as different electric motors.

In the embodiments, the power steering apparatus has been described referring to the example in which the output assignment ratio is changed in the continuous manner, but the output assignment ratio may be changed in a stepwise manner.

In the following description, other configurations recognizable from the above-described embodiments will be described.

A power steering apparatus, according to one configuration thereof, includes a steering mechanism configured to transmit a steering operation on a steering wheel to a turning target wheel, a first actuation portion and a second actuation portion configured to provide a steering force to the steering mechanism, a controller configured to output a first driving instruction signal for controlling driving of the first actuation portion and a second driving instruction signal for controlling driving of the second actuation portion, and an output distribution control portion provided in the controller and configured to change output ratios of steering forces of the first actuation portion and the second actuation portion. The output distribution control portion is configured to perform output distribution control of changing the first driving instruction signal and the second driving instruction signal so as to increase the output ratio of the steering force of one of the first actuation portion and the second actuation portion and reduce the output ratio of the steering force of the other of the first actuation portion and the second actuation portion to a value greater than zero.

According to a further preferable configuration, in the above-described configuration, the power steering apparatus further includes a torque sensor including a first detection portion configured to detect a steering torque of the steering mechanism to output a first torque signal and a second detection portion configured to detect the steering torque to output a second torque signal. The controller includes a first microprocessor configured to output the first driving instruction signal based on the first torque signal, a first inverter configured to supply power to the first actuation portion based on the first driving instruction signal, a second microprocessor configured to output the second driving instruction signal based on the second torque signal, a second inverter configured to supply power to the second actuation portion based on the second driving instruction signal, and an abnormality determination portion configured to determine whether there is an abnormality in the torque sensor, the first microprocessor, the first inverter, the second microprocessor, the second inverter, the first actuation portion, or the second actuation portion. The output distribution control portion reduces the output ratio of the first actuation portion and increases the output ratio of the second actuation portion when the abnormality is determined to be present in any component in a first system including the first detection portion, the first microprocessor, the first inverter, and the first actuation portion. On the other hand, the output distribution control portion reduces the output ratio of the steering force of the second actuation portion and increases the output ratio of the steering force of the first actuation portion when the abnormality is determined to be present in any component in a second system including the second detection portion, the second microprocessor, the second inverter, and the second actuation portion.

According to another preferable configuration, in any of the above-described configurations, the abnormality determination portion includes an abnormality detection portion configured to detect the abnormality in the first system or the second system, and an abnormality confirmation portion configured to confirm the abnormality after the abnormality detection portion detects the abnormality. The output distribution control portion performs the output distribution control since the abnormality detection portion detects the abnormality until the abnormality confirmation portion confirms the abnormality.

According to further another preferable configuration, in any of the above-described configurations, the output distribution control portion ends the output distribution control by the time the abnormality confirmation portion confirms the abnormality.

According to further another preferable configuration, in any of the above-described configurations, the output distribution control portion reduces the output ratio of the steering force of one of the first system and the second system where the abnormality is detected to zero by the time the abnormality confirmation portion confirms the abnormality.

According to further another preferable configuration, in any of the above-described configurations, the controller calculates a required amount of the steering force to be provided to the steering mechanism based on the first torque signal or the second torque signal. The output distribution control portion performs the output distribution control so as to cause even one of the first system and the second system where the abnormality is detected to continue providing the steering force during a period since the abnormality detection portion detects the abnormality until the abnormality confirmation portion confirms the abnormality, when the required amount exceeds a steering force that the first actuation portion or the second actuation portion can output alone.

According to further another preferable configuration, in any of the above-described configurations, the controller calculates a required amount of the steering force to be provided to the steering mechanism based on the first torque signal or the second torque signal. The output distribution control portion reduces the output ratio of the steering force of one of the first system and the second system where the abnormality is detected to zero by the time the abnormality confirmation portion confirms the abnormality, when the required amount is equal to or smaller than a steering force that the first actuation portion or the second actuation portion can output alone.

According to further another preferable configuration, in any of the above-described configurations, the abnormality determination portion includes a first abnormality determination portion provided in the first microprocessor and configured to determine whether there is an abnormality in the first system, and a second abnormality determination portion provided in the second microprocessor and configured to determine whether there is an abnormality in the second system. The output distribution control portion includes a first output distribution control portion provided in the first microprocessor and a second output distribution control portion provided in the second microprocessor. The first output distribution control portion starts the output distribution control when receiving from the second abnormality determination portion a signal indicating that there is the abnormality in the second system. The second output distribution control portion starts the output distribution control when receiving from the first abnormality determination portion a signal indicating that there is the abnormality in the first system.

According to further another preferable configuration, in any of the above-described configurations, the first abnormality determination portion transmits a signal regarding a cause of the abnormality in the first system to the second microprocessor. The second abnormality determination portion transmits a signal regarding a cause of the abnormality in the second system to the first microprocessor.

According to further another preferable configuration, in any of the above-described configurations, the first output distribution control portion ends the output distribution control earlier when the cause of the abnormality in the second system lies in the second inverter or the second actuation portion than when the cause of the abnormality in the second system lies in the second detection portion. The second output distribution control portion ends the output distribution control earlier when the cause of the abnormality in the first system lies in the first inverter or the first actuation portion than when the cause of the abnormality in the first system lies in the first detection portion.

According to further another preferable configuration, in any of the above-described configurations, the first output distribution control portion performs the output distribution control so as to immediately reduce the output ratio of the steering force of the second actuation portion to zero when receiving from the second abnormality determination portion the signal indicating that there is the abnormality in the second system, if the cause of the abnormality in the second system lies in the second inverter or the second actuation portion. The second output distribution control portion performs the output distribution control so as to immediately reduce the output ratio of the steering force of the first actuation portion to zero when receiving from the first abnormality determination portion the signal indicating that there is the abnormality in the first system, if the cause of the abnormality in the first system lies in the first inverter or the first actuation portion.

According to further another preferable configuration, in any of the above-described configurations, the abnormality determination portion includes a first abnormality confirmation portion provided in the first microprocessor and configured to confirm the abnormality after the first abnormality detection portion detects the abnormality in the first system, and a second abnormality confirmation portion provided in the second microprocessor and configured to confirm the abnormality after the second abnormality detection portion detects the abnormality in the second system. The first output distribution control portion performs the output distribution control so as to cause the second actuation portion to continue providing the steering force with use of the first torque signal even after the second abnormality confirmation portion confirms the abnormality in the second system, if the cause of the abnormality in the second system lies in the second detection portion. The second output distribution control portion performs the output distribution control so as to cause the first actuation portion to continue providing the steering force with use of the second torque signal even after the first abnormality confirmation portion confirms the abnormality in the first system, if the cause of the abnormality in the first system lies in the first detection portion.

According to further another preferable configuration, in any of the above-described configurations, the first output distribution control portion determines the output ratios of the steering forces of the first actuation portion and the second actuation portion when receiving from the second abnormality determination portion the signal indicating that there is the abnormality in the second system. The second output distribution control portion determines the output ratios of the steering forces of the first actuation portion and the second actuation portion when receiving from the first abnormality determination portion the signal indicating that there is the abnormality in the first system.

According to further another preferable configuration, in any of the above-described configurations, the first output distribution control portion outputs a torque instruction value to the second microprocessor when receiving from the second abnormality determination portion the signal indicating that there is the abnormality in the second system. The second output distribution control portion outputs a torque instruction value to the first microprocessor when receiving from the first abnormality determination portion the signal indicating that there is the abnormality in the first system.

According to further another preferable configuration, in any of the above-described configurations, the output distribution control portion continuously increases the output ratio of one of the steering forces of the first actuation portion and the second actuation portion and continuously reduces the output ratio of the other of the steering forces.

According to further another preferable configuration, in any of the above-described configurations, the controller includes a first upper limit value setting portion and a second upper limit value setting portion configured to set upper limit values on the first driving instruction signal and the second driving instruction signal processed by the output distribution control portion.

The present application claims priority to Japanese Patent Application No. 2016-169974 filed on Aug. 31, 2016. The entire disclosure of Japanese Patent Application No. 2016-169974 filed on Aug. 31, 2016 including the specification, the claims, the drawings, and the abstract is incorporated herein by reference in its entirety.

### REFERENCE SIGN LIST

1 steering mechanism
2 steering wheel
3 front wheel (turning target wheel)
11 electric motor (first actuation portion and second actuation portion)
11a first wiring pair (first actuation portion)
11b second wiring pair (second actuation portion)
15a first steering torque sensor (first detection portion)
15b second steering torque sensor (second detection portion)
16 ECU (controller)
23a first MPU (first microprocessor)
23b second MPU (second microprocessor)
25a first inverter
25b second inverter
45a first diagnosis function portion (first abnormality determination portion)
44b second diagnosis function portion (second abnormality determination portion)
46a first output distribution control portion
46b second output distribution control portion
47a first assist limit portion (first upper limit value setting portion)
47b second assist limit portion (second upper limit value setting portion)
51a first abnormality detection portion
51b second abnormality detection portion
52a first abnormality confirmation portion
52b second abnormality confirmation portion

1. A power steering apparatus comprising:
a steering mechanism configured to transmit a steering operation on a steering wheel to a turning target wheel;
a first actuation portion and a second actuation portion configured to provide a steering force to the steering mechanism; and
a controller configured to output a first driving instruction signal for controlling driving of the first actuation portion, and a second driving instruction signal for controlling driving of the second actuation portion,
wherein the controller includes an output distribution control portion configured to change a ratio of the output of the first driving instruction signal and a ratio of the output of the second driving instruction signal, and perform output distribution control of increasing the output ratio of one of the first driving instruction signal and the second driving instruction signal and reducing the output ratio of the other of the first driving instruction signal and the second driving instruction signal to a value greater than zero.

2. The power steering apparatus according to claim 1, further comprising a torque sensor including a first detection portion configured to detect a steering torque of the steering mechanism to output a first torque signal, and a second detection portion configured to detect the steering torque to output a second torque signal,
wherein the controller includes
a first microprocessor configured to output the first driving instruction signal based on the first torque signal,
a first inverter configured to supply power to the first actuation portion based on the first driving instruction signal,
a second microprocessor configured to output the second driving instruction signal based on the second torque signal,
a second inverter configured to supply power to the second actuation portion based on the second driving instruction signal, and
an abnormality determination portion configured to determine whether there is an abnormality in the torque sensor, the first microprocessor, the first inverter, the second microprocessor, the second inverter, the first actuation portion, or the second actuation portion,
wherein the output distribution control portion reduces the output ratio of the first driving instruction signal and increases the output ratio of the second driving instruction signal when the abnormality is determined to be present in any component in a first system including the first detection portion, the first microprocessor, the first inverter, and the first actuation portion, and
wherein the output distribution control portion reduces the output ratio of the second driving instruction signal and increases the output ratio of the first driving instruction signal when the abnormality is determined to be present in any component in a second system including the second detection portion, the second microprocessor, the second inverter, and the second actuation portion.

3. The power steering apparatus according to claim 2, wherein the abnormality determination portion includes an abnormality detection portion configured to detect the abnormality in the first system or the second system, and an abnormality confirmation portion configured to confirm the abnormality after the abnormality detection portion detects the abnormality, and
wherein the output distribution control portion performs the output distribution control since the abnormality detection portion detects the abnormality until the abnormality confirmation portion confirms the abnormality.

4. The power steering apparatus according to claim 3, wherein the output distribution control portion ends the output distribution control by the time the abnormality confirmation portion confirms the abnormality.

5. The power steering apparatus according to claim 4, wherein the output distribution control portion reduces the output ratio of one of the first system and the second system where the abnormality is detected to zero by the time the abnormality confirmation portion confirms the abnormality.

6. The power steering apparatus according to claim 3, wherein the controller calculates a required amount of the steering force to be provided to the steering mechanism based on the first torque signal or the second torque signal, and
wherein the output distribution control portion performs the output distribution control so as to cause even one of the first system and the second system where the abnormality is detected to continuously generate the steering force during a period since the abnormality detection portion detects the abnormality until the abnormality confirmation portion confirms the abnormality, when the required amount exceeds a steering force that the first actuation portion or the second actuation portion can output alone.

7. The power steering apparatus according to claim 3, wherein the controller calculates a required amount of the steering force to be provided to the steering mechanism based on the first torque signal or the second torque signal, and
wherein the output distribution control portion reduces the output ratio of one of the first system and the second system where the abnormality is detected to zero by the time the abnormality confirmation portion confirms the abnormality, when the required amount is equal to or smaller than a steering force that the first actuation portion or the second actuation portion can output alone.

8. The power steering apparatus according to claim 2, wherein the abnormality determination portion includes a first abnormality determination portion provided in the first microprocessor and configured to determine whether there is an abnormality in the first system, and a second abnormality determination portion provided in the second microprocessor and configured to determine whether there is an abnormality in the second system,
wherein the output distribution control portion includes a first output distribution control portion provided in the first microprocessor and a second output distribution control portion provided in the second microprocessor,
wherein the first output distribution control portion starts the output distribution control when receiving from the second abnormality determination portion a signal indicating that there is the abnormality in the second system, and
wherein the second output distribution control portion starts the output distribution control when receiving from the first abnormality determination portion a signal indicating that there is the abnormality in the first system.

9. The power steering apparatus according to claim 8, wherein the first abnormality determination portion transmits a signal regarding a cause of the abnormality in the first system to the second microprocessor, and
wherein the second abnormality determination portion transmits a signal regarding a cause of the abnormality in the second system to the first microprocessor.

10. The power steering apparatus according to claim 9, wherein the first output distribution control portion ends the output distribution control earlier when the cause of the abnormality in the second system lies in the second inverter or the second actuation portion than when the cause of the abnormality in the second system lies in the second detection portion, and
wherein the second output distribution control portion ends the output distribution control earlier when the cause of the abnormality in the first system lies in the first inverter or the first actuation portion than when the cause of the abnormality in the first system lies in the first detection portion.

11. The power steering apparatus according to claim 10, wherein the first output distribution control portion performs the output distribution control so as to immediately reduce the output ratio of the second actuation portion to zero after receiving from the second abnormality determination portion the signal indicating that there is the abnormality in the second system, if the cause of the abnormality in the second system lies in the second inverter or the second actuation portion, and
wherein the second output distribution control portion performs the output distribution control so as to immediately reduce the output ratio of the first actuation portion to zero after receiving from the first abnormality determination portion the signal indicating that there is the abnormality in the first system, if the cause of the abnormality in the first system lies in the first inverter or the first actuation portion.

12. The power steering apparatus according to claim 10, wherein
the abnormality determination portion includes a first abnormality confirmation portion provided in the first microprocessor and configured to confirm the abnormality after the first abnormality detection portion detects the abnormality in the first system, and a second abnormality confirmation portion provided in the second microprocessor and configured to confirm the abnormality after the second abnormality detection portion detects the abnormality in the second system,
wherein the first output distribution control portion performs the output distribution control so as to cause the second actuation portion to continue providing the steering force with use of the first torque signal even after the second abnormality confirmation portion confirms the abnormality in the second system, if the cause of the abnormality in the second system lies in the second detection portion, and
wherein the second output distribution control portion performs the output distribution control so as to cause the first actuation portion to continue providing the steering force with use of the second torque signal even after the second abnormality confirmation portion confirms the abnormality in the second system, if the cause of the abnormality in the first system lies in the first detection portion.

13. The power steering apparatus according to claim 8, wherein the first output distribution control portion determines the ratios of the outputs of both the first actuation portion and the second actuation portion when receiving from the second abnormality determination portion the signal indicating that there is the abnormality in the second system, and
wherein the second output distribution control portion determines the ratios of the outputs of both the first actuation portion and the second actuation portion when receiving from the first abnormality determination portion the signal indicating that there is the abnormality in the first system.

14. The power steering apparatus according to claim 13, wherein the first output distribution control portion outputs a torque instruction value to the second microprocessor when receiving from the second abnormality determination portion the signal indicating that there is the abnormality in the second system, and
wherein the second output distribution control portion outputs a torque instruction value to the first microprocessor when receiving from the first abnormality determination portion the signal indicating that there is the abnormality in the first system.

15. The power steering apparatus according to claim 1, wherein the output distribution control portion continuously increases the output ratio of one of the first driving signal and the second driving signal and continuously reduces the output ratio of the other of the first driving signal and the second driving signal.

16. The power steering apparatus according to claim 1, wherein the controller includes a first upper limit value setting portion configured to set an upper limit value on the first driving instruction signal, and a second upper limit value setting portion configured to set an upper limit value on the second driving instruction signal, and
wherein the output distribution control portion performs the output distribution control based on the signal processed by each of the first upper limit value setting portion and the second upper limit value setting portion.
